(19) United States
(12) Patent Application Publication
(10) Pub. No.: US 2024/0270210 A1
(43) Pub. Date: Aug. 15, 2024

(54) DISTRIBUTION DEVICE AND LIQUID DISTRIBUTION ACTUATOR

(71) Applicant: Vitesco Technologies GmbH, Regensburg (DE)

(72) Inventors: Wolf Goetze, Rotenburg (DE); Matthias Fischer, Ringgau (DE); Bjoern Bartholmai, Sontra (DE)

(73) Assignee: Vitesco Technologies GmbH, Regensburg (DE)

(21) Appl. No.: 18/442,404

(22) Filed: Feb. 15, 2024

Related U.S. Application Data
(63) Continuation of application No. PCT/EP2022/071214, filed on Jul. 28, 2022.

(30) Foreign Application Priority Data
Aug. 16, 2021 (DE) 10 2021 208 936.4

(51) Int. Cl. B60S 1/48; B60S 1/56

(52) U.S. Cl. CPC B60S 1/481; B60S 1/56

(57) ABSTRACT

A distributing device for supplying a pressurized liquid to individual cleaning locations of a vehicle. The distributing device has a housing having an inlet connection, a plurality of outlet connections for the individual cleaning locations and a return connection, and an electromotively drivable, rotatably adjustable distributor which is arranged therein and which is in the form of a disk, in which liquid receiving means and liquid guiding means are formed. The distributor is rotatably adjustable relative to the housing in defined positions in order to allow or to prevent the supply of liquid. The disk controls or guides the liquid to the desired locations of the distributing device via a liquid receiving means and liquid guiding means at the front side in the form of a radial groove.

### CROSS-REFERENCE TO RELATED APPLICATIONS

This application claims priority to PCT Application PCT/EP2022/071214, filed Jul. 28, 2022, which claims priority to German Patent Application No. DE 10 2021 208 936.4, filed Aug. 16, 2021. The disclosures of the above applications are incorporated herein by reference.

### FIELD OF THE INVENTION

The invention relates to a distributing device for a liquid-distributing actuator and to a liquid-distributing actuator with such a distributing device.

### SUMMARY OF THE INVENTION

It is an object of the invention to improve a distribution of water for a vehicle cleaning arrangement, specifically in view of the increasing number of vehicle sensors.

This object is achieved by way of a distributing device proposed. Furthermore, a liquid-distributing actuator with such a distributing device is proposed. Furthermore, a cleaning device and a vehicle are proposed. Additional embodiments of the invention are the subject matter described.

A distributing device for supplying a pressurized liquid to individual cleaning locations of a vehicle is proposed.

In this case, the distributing device has a housing having an inlet connection, a plurality of outlet connections for the individual cleaning locations and a return connection, and an electromotively drivable, rotatably adjustable distributor which is arranged therein and which is in the form of a disk, in which liquid receiving means, i.e., a liquid receiver, and liquid guiding means, i.e., a liquid guide, are formed. In this case, the distributor is rotatably adjustable relative to the housing in defined positions in order to allow or to prevent the supply of liquid.

In this case, the distributing disk controls or guides the liquid to the desired locations of the distributing device via a liquid receiving means and liquid guiding means at the front side in the form of a radial groove or a radial channel.

This proposed water-distributing mechanism simplifies a vehicle cleaning apparatus or a vehicle cleaning system and consequently reduces the costs associated therewith because liquid conveying pumps and valve blocks with separately actuatable valves are thereby saved. There is consequently also an associated weight saving. Since conveying pumps are saved on, corresponding pump activation is also simplified.

Furthermore, this proposed water-distributing mechanism reduces cleaning liquid consumption. This in turn is manifest in an increase in a range of a vehicle that is achieved as such with one filling of a cleaning liquid container or tank. This applies for example to future fully autonomously driving vehicles which, compared to previous vehicles, may have a significantly greater number of sensors—including safety-relevant sensors—whose functionality must be ensured.

Furthermore, the saving of required apparatus or system components also promotes corresponding compactness of such an apparatus or of such a system, such that overall less installation space is required.

Here, a cleaning location may be understood to mean a cleaning location assigned to a vehicle sensor. Here, this cleaning location need not itself be part of the sensor, but may be arranged spaced apart therefrom, for example a location on a windshield or the like. The cleaning location may however also be part of a vehicle sensor, for example a cleaning location assigned to a camera. A cleaning location may however also be another location of the vehicle which is not associated with a vehicle sensor as such, for example another location on the windshield, a location on a headlight and the like.

Here, in the simplest case, a liquid or cleaning liquid may be understood to mean water, such as an aqueous cleaning agent solution, that is to say, water in combination with a cleaning agent additive. Here, the cleaning agent solution may also contain an antifreeze agent, which as such lowers the freezing point of the cleaning agent solution.

Here, the distributor of the distributing device is formed without a seal with respect to the housing of the distributing device. It is therefore proposed that a return of liquid to a tank be provided. To this end, a coherent space which is filled by conveyed liquid during operation of the distributing device between the disk and the housing is fluidically connected to the return connection.

During operation of the distributing device, the disk forms, at the front side with the associated housing portion or housing section, a defined axial gap, via which conveyed liquid propagates in the housing and in this instance forms at the front side a liquid leakage film or a liquid leakage flow which spaces the distributor apart from the housing.

It is proposed that the distributing disk be formed symmetrically or in a mirror-symmetrical manner with respect to an axis orthogonal to the longitudinal axis of the distributing disk in order to be able to produce a hydrostatic balance in the housing or on the distributor or the distributing disk.

In this case, it is further proposed that the disk be provided with pressure equalization means in the form of through-holes.

There is further proposed a liquid-distributing actuator which includes a distributing device or distribution device of the type described above and an electric motor for driving the rotatably adjustable distributor of the distributing device.

Furthermore, there is proposed a cleaning apparatus or a cleaning system for a vehicle for cleaning a large number of cleaning locations on the vehicle, wherein the cleaning apparatus or the cleaning system includes at least one liquid-distributing actuator of the type described above.

In addition, a vehicle having a cleaning apparatus of the type described above is also proposed.

A vehicle is to be understood here to mean any type of vehicle which is operated by combustion engine and/or electric motor, but in an embodiment passenger motor vehicles and/or utility vehicles. These are, in an embodiment, partially autonomously and may be fully autonomously operated vehicles.

The invention will be explained in detail below with reference to the illustrations in the Figures. Further advantageous refinements of the invention emerge from the description below of various embodiments.

### BRIEF DESCRIPTION OF THE DRAWINGS

In this respect:

FIG. 1 shows a proposed liquid-distributing actuator in a first perspective view;

FIG. 2 shows the actuator shown in FIG. 1 in a second perspective view;

FIG. 3 shows the actuator shown in FIG. 1 in a third perspective view;

FIG. 4 shows the distributor shown in FIG. 1 in a perspective view;

FIG. 5 shows a first housing portion which is shown in FIG. 1 in a perspective view; and

FIG. 6 shows a second housing portion which is shown in FIG. 1 in a perspective view.

### DETAILED DESCRIPTION OF THE PREFERRED EMBODIMENTS

The following description of the preferred embodiment(s) is merely exemplary in nature and is in no way intended to limit the invention, its application, or uses.

The proposed liquid-distributing actuator A serves to supply individual cleaning locations (RS=cleaning location; RSᵢ, RSᵢ₊₁, . . . , RSᵢ₊ₙ) of a vehicle with a pressurized liquid or cleaning liquid.

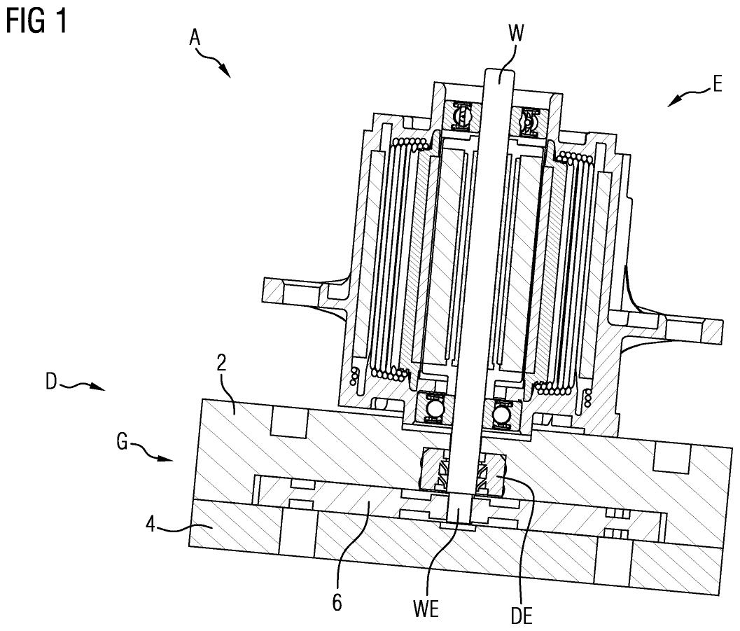

In this instance, the actuator A includes a distributing device or distribution device D having a, for example, substantially cylindrical housing G which has a first housing portion 2 and a second housing portion 4. In this case, these two housing portions 2, 4 form in the joined state a housing chamber, in which a distributor 6—or a distributing disk 6—is arranged in a rotatably adjustable manner (FIG. 1). The two housing portions 2, 4 and the distributing disk 6 are produced in this case, for example, from a duroplastic plastics material or a thermoplastic plastics material, for instance, a PPS-GF material.

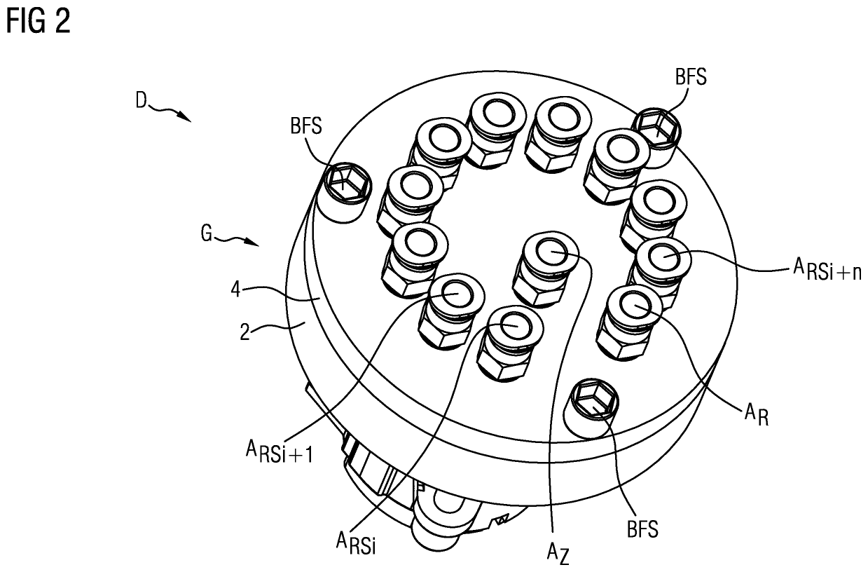

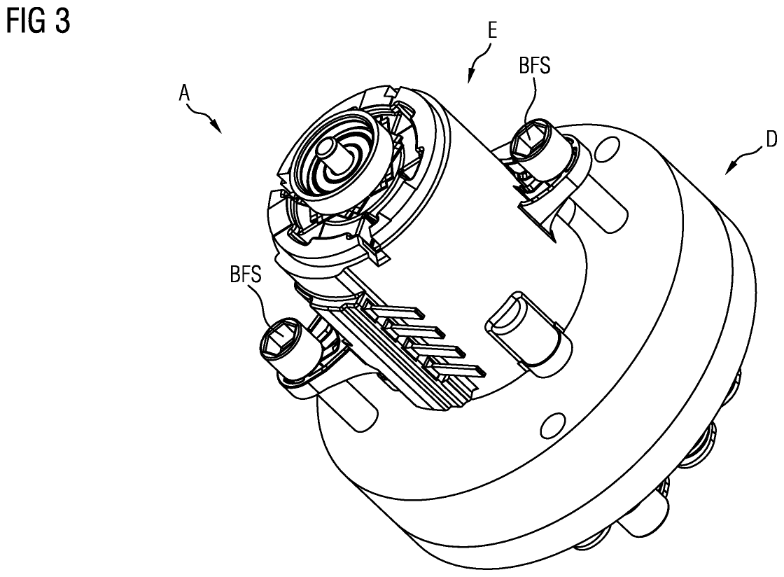

The actuator A further includes an electric motor or E-motor E which is joined to the housing portion 2 and which is, for example, screwed to the two housing portions 2, 4 (see to this end the securing screws BFS in FIG. 2 or FIG. 3). Alternatively to screwing, for example, it is also possible to roll these housing portions 2, 4 with respect to each other, for example, by means of a sheet metal covering. Such rolling could in this case also include, for example, the electric motor E. The electric motor E is in this case, for example, in the form of a dry rotor. Alternatively, the electric motor E may also be in the form of a wet rotor and in this case may have a containment shell or a can which separates a wet chamber from a dry chamber and in which the rotor of the electric motor E is flushed or flowed around by conveyed liquid (wet chamber). However, the stator of the electric motor is located in this instance in the dry chamber. A shaft of the electric motor E extends in this case through the housing portion 2 and a sealing element DE, which is arranged in the housing portion 2 and in this case seals with respect to the housing portion 2 and the shaft W, as far as the distributor 6, wherein the shaft end WE engages in the distributor 6 in a positive-locking manner (FIG. 1).

FIG. 2 illustrates the end, at the hydraulic connection side, of the actuator A which includes a large number of hydraulic connections. In detail, this end includes an inlet connection A_{Z}, a plurality of outlet connections A_{RSi}, A_{RSi+1} . . . A_{RSi+n}—corresponding to the number of mentioned cleaning locations RSᵢ, RSᵢ₊1 . . . , RSᵢ₊ₙ of the vehicle, and an additional outlet connection in the form of a return connection A_{R}. FIG. 2 further illustrates in this case individual hydraulic connection elements which are screwed per se, for example, into a corresponding threaded hole of the housing portion 4.

FIG. 3 illustrates the electromotive portion of the actuator A and the end, at the electrical connection, of the actuator A with electrical contacts or pins.

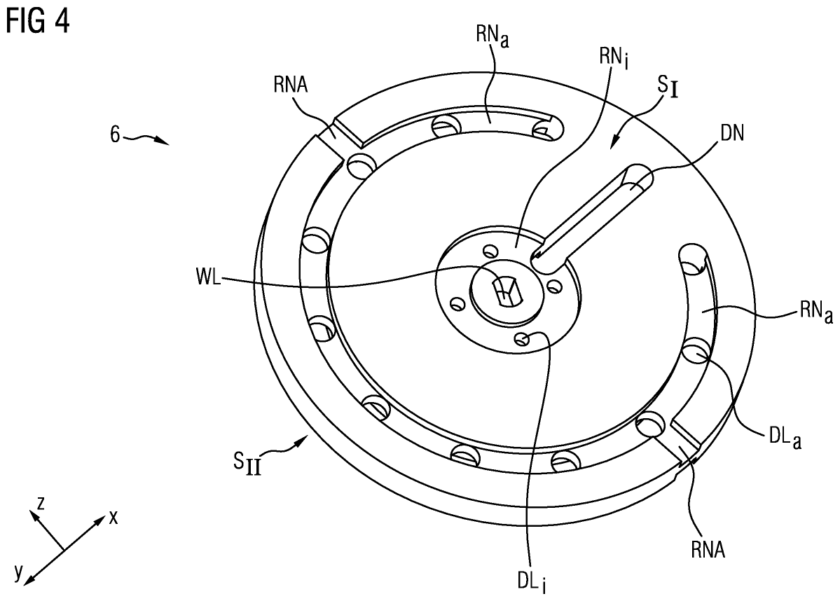

FIG. 4 illustrates the above-mentioned distributor 6 which is in the form of a disk. The two front sides S_{I}, S_{II} of the distributor 6 are in this instance formed in an identical manner, that is to say, symmetrically or in a mirror-symmetrical manner with respect to an axis Y-Y, Z-Z which is orthogonal to the longitudinal axis X-X of the distributor 6 in order to be able to generate during operation of the actuator A a hydrostatic balance—in the direction X-X—on the distributor 6 or inside the housing G, 2, 4 so that the distributor 6 remains spaced apart from the housing. In this case, radially internal and radially external through-holes DLᵢ, DLₐ extend through the distributor 6 and all contribute to the formation of the hydrostatic balance.

Furthermore, indentations in the form of recesses are formed at both front sides S_{I}, S_{II}. In this case, a first internal recess in the form of a first, inner annular groove RNᵢ surrounds the mentioned shaft hole WL in which the shaft end WE which complements it (FIG. 1) engages in a positive-locking manner. Furthermore, for example, four through-holes DLᵢ are arranged in this annular groove RNᵢ and in this case, for example, arranged with identical spacing from each other.

A longitudinal groove or radial longitudinal groove in the form of a through-groove DN—which constitutes a radial channel per se—extends from this annular groove RNᵢ radially outwardly as far as a location between the two ends of an external recess in the form of a second external annular groove RNₐ which does not extend completely round or is not closed and which does not completely surround the annular groove RNᵢ but mainly does so. In this case, for example, eleven through-holes DLₐ are arranged in this annular groove RNₐ and, for example, in this case arranged with identical spacing from each other.

In this case, this through-groove DN is in the form of a closed profile, or a profile which extends in a closed manner, in FIG. 4. That is to say, it does not extend as far as the outer face, on the radial circumference, of the distributing disk 6.

Furthermore, two radial groove portions RNA which are formed per se at both sides of the through-groove DN and which are arranged in a state offset by 90° relative thereto branch off from the annular groove RNₐ (cf. FIG. 4).

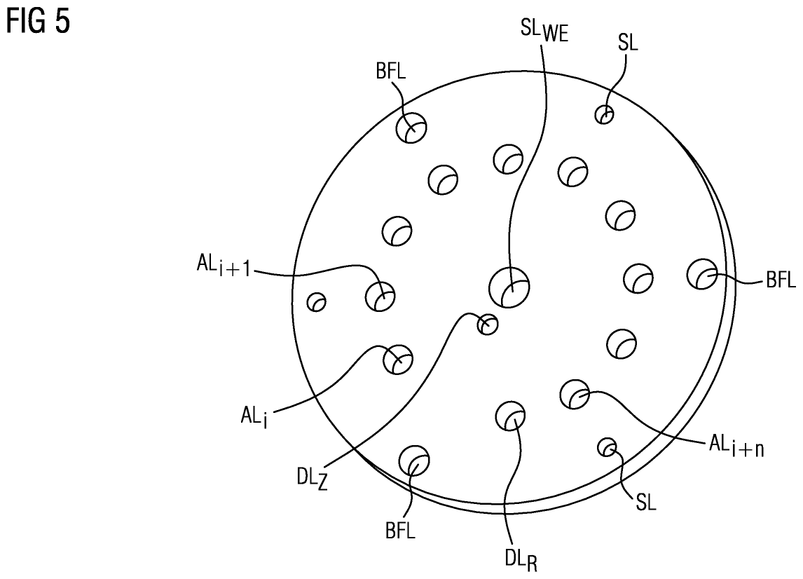

FIG. 5 illustrates the housing portion 4 which has a number of through-holes DL_{Z}, DL_{A}, DL_{RSi}, DL_{RSi+1}, . . . , DL_{RSi+n} which corresponds to the number of hydraulic connections—in this case, for example, a total of eleven through-holes—which are further provided with a thread in order to be able to screw in the hydraulic connection elements, which are mentioned in the introduction, from the opposite side or front side of the housing portion 2.

Furthermore, there are formed in the housing portion 4 (cf. FIG. 5) securing holes or through-holes BFL, via which the two housing portions 2, 4 are screwed to each other. However, the electric motor E is screwed only to the housing portion 2 (cf., for example, FIG. 3).

Furthermore, pin holes or pinning holes in the form of, for example, blind holes SL, via which the housing portions 2, 4 are orientated relative to each other and pinned or joined together is seen in the housing portion 4.

Furthermore, a blind hole SL_{WE}, in which the shaft end WE extends, is formed in the middle of the housing portion 4. The inlet through-hole DL_{Z}, via which the liquid is conveyed into the housing G, 2, 4, is located beside it.

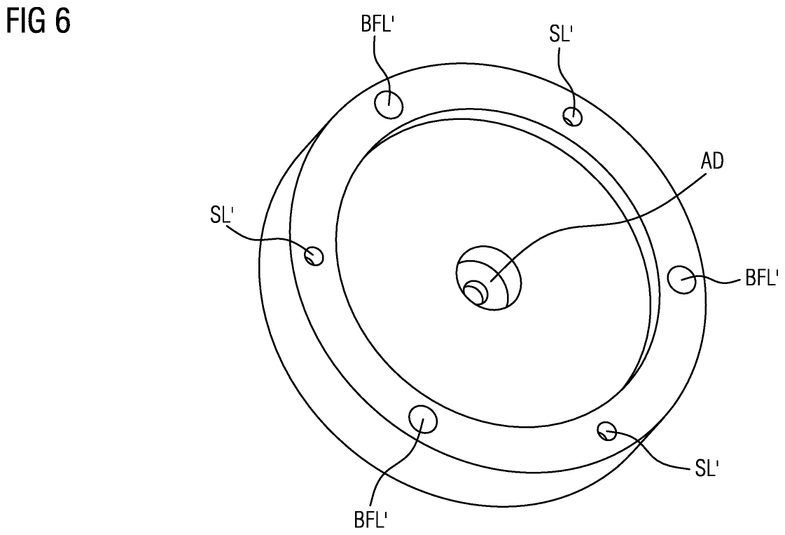

FIG. 6 illustrates the housing portion 2 which is similar in form to the housing portion 4 with respect to the securing holes BFL′—for example, in the form of blind holes with an internal thread—and the pin holes SL′—for example, in the form of blind holes. Furthermore, a recess AD for receiving the sealing element DE which is mentioned in the introduction is located at the center of the housing portion 2.

Furthermore, there may also be formed in the two housing portions 2, 4 at the front side and so as to face the distributing disk 6 recesses in the form of indentations which—in addition to the recesses of the distributing disk 6 in the front side—contribute to forming a balanced hydraulic bearing of the distributing disk 6 over the entire adjustment range thereof or ensure such a hydraulic bearing. These additional indentations or recesses in the housing portions 2, 4 may be configured or formed in this case identically and are further located precisely opposite each other.

In another embodiment, either only the housing portion 2 or only the housing portion 4 is configured with at least one such indentation in the form of a recess at the front side and facing the distributing disk 6.

In another embodiment, there is additionally configured on the housing portion 2 and/or on the housing portion 4 a groove, at the front side and facing the distributing disk 6, which per se fluidically connects the radial gap between the circumferential side of the distributing disk 6 or the radially circumferential outer face of the distributing disk 6 and the housing G, 2, 4 to the return connection A_{R}. Such a groove brings about a pressure reduction in a so-called flushing position or flushing location or neutral position or neutral location of the distributing disk 6, wherein the flushing position and neutral position is further described below.

In another alternative embodiment, the housing G further includes a closed, circumferential spacer ring which per se is arranged between the housing portion 2 and the housing portion 4 and which spaces these two housing portions away from each other. This spacer ring also forms the housing chamber which receives the distributing disk 6 in this case.

The functioning of the proposed distributing mechanism is described below.

During operation of the actuator A, the distributor 6 or the distributing disk 6 is flushed or flowed around by conveyed liquid inside the space, which receives it, of the housing G, 2, 4.

The distributing device D is supplied with pressurized liquid via the inlet connection A_{Z} and the inlet through-hole DL_{Z}. The inlet connection A_{Z} is located in this instance slightly eccentrically on the housing G, 4 and furthermore at the height of the internal annular groove RNᵢ of the front side S_{I} of the distributing disk 6 (cf. FIG. 4). Therefore, the liquid initially strikes this annular groove RNᵢ, via which it then becomes distributed over the entire housing chamber. In this case, on the one hand, it reaches via the through-holes DLᵢ the opposite front side S_{II} of the distributing disk 6. Via the two axial gaps which the distributing disk 6 forms at the front side with the associated housing portion 2, 4 in a defined manner, the liquid spreads over the respective front side S_{I}, S_{II} and forms in this case a liquid leakage film at the front side or a liquid leakage flow at the front side which accordingly spaces the distributing disk 6 away from the associated housing portion 2, 4.

In this case, the liquid further reaches the radial gap between the circumferential side of the distributing disk 6 and the housing G, 2, 4. In this instance, the two radial groove portions RNA promote or support the outflow of the liquid from the radial gap to the mentioned return connection A_{R} (FIG. 2) or mentioned outlet through-hole or return through-hole DL_{R} (FIG. 5).

Furthermore, the liquid reaches the radial through-groove DN, by which the distributing disk 6 controls or guides the liquid—depending on the orientation of the distributing disk 6 in the housing chamber—to the desired location of the distributing device.

Depending on the orientation or rotational adjustment of the distributing disk 6, either one of the mentioned cleaning locations of the vehicle is supplied with liquid by one of the outlet connections A_{RSi}, A_{RSi+1} . . . A_{RSi+n} being accordingly acted on via the radial through-groove DN, or the liquid supply is completely prevented by the distributing disk 6 taking up a so-called cleaning position or cleaning location. In the latter case, the distributing disk 6 is orientated relative to the housing G, 2, 4 in such a manner that the liquid directly acts on the return connection A_{R} (FIG. 2) or the outlet through-hole or return through-hole DL_{R} (FIG. 5), via which it is returned to a liquid tank from which it was previously conveyed.

In this flushing position, the conveyed liquid is recirculated in a circuit of a cleaning apparatus of the vehicle, to which the liquid-distributing actuator A belongs. In this case, the distributing device D and the cleaning apparatus may be cleaned and/or vented. In this case, a minimal pressure level is further produced in the housing chamber mentioned.

Furthermore, there may also be provided an additional position—a so-called neutral position or neutral location—of the distributing disk 6, in which the distributing disk 6 is rotatably adjustable and in which the radial through-groove DN acts on a position between the return through-hole DL_{R} and the connection through-hole ALᵢ (cf. FIG. 5). In this neutral position, the liquid supply of the individual cleaning locations is also prevented. In this case, a higher or maximum pressure level is produced in the housing chamber with respect to the above-described position, in which the radial through-groove DN directly acts on the return connection A_{R} (FIG. 2) or the outlet through-hole or return through-hole DL_{R} (FIG. 5).

In this neutral position—also referred to as a blocking position—of the distributing disk 6, all outlet connections A_{RSi}, A_{RSi+1} . . . A_{RSi+n}—which lead to a cleaning location remain closed except for the return connection A_{R}. This is achieved by a corresponding non-return valve (not illustrated) being associated with each of these outlet connections A_{RSi}, A_{RSi+1} . . . A_{RSi+n} and opening only from a specific liquid pressure. In this case, only the liquid leakage which is produced in this neutral position is discharged via the return connection A_{R} or guided back to the liquid tank.

These two mutually different pressure levels may be used for diagnostic purposes in this instance.

The pressure or the pressure level in the housing chamber is, for example, approximately from 3 to 8 bar in this case.

It is also possible, with the position or the location of the rotor of the electric motor E in a circumferential direction ΔΦ being determined, to determine the mentioned relative position of the radial through-groove DN in relation to the individual positions of the housing.

At least one sensor which is fitted in and/or on the electric motor E provides the mentioned position or location of the rotor in this instance, for example, a Hall sensor. Additionally or alternatively, it is also possible to use directly a current and voltage information item from the electric motor E to determine the rotor position or rotor location.

Irrespective of the position of the distributing disk 6, the liquid leakage which is produced in the housing chamber at the two axial gaps and in the radial gap is guided back into the liquid tank via the return through-hole DL_{R} (cf. FIG. 5) and the return connection A_{R} (cf. FIG. 2)—at least from a specific minimum pressure level in the housing chamber. A contribution is also made by the fact that the return through-hole DL_{R} (cf. FIG. 5) and the return connection A_{R} (cf. FIG. 2) are located at the height of the annular groove RNₐ.

The proposed distributing mechanism is characterized during operation by minimal axial gaps at the front side, which minimize a liquid leakage in the housing chamber per se.

The axial gaps produced are in the region of up to approximately 10 μm in this case. That is to say, in total the axial gap between the distributing disk 6 and the housing G, 2, 4 is up to a maximum of approximately 20 μm.

The liquid volume which is reduced by these minimum axial gaps in the housing chamber further promotes in this case a high freezing protection of the distributing device D.

The symmetrical or at least substantially symmetrical distributing disk 6 is further characterized in this instance in that it may be rotatably adjusted virtually without force and further has a small moment of inertia. This is associated with a relatively small energy requirement and very short switching times for the rotational adjustment of the distributing disk 6.

In the exemplary embodiment depicted by the Figures, the drive shaft W of the electric motor E is received or supported by a fixed bearing on the housing and a movable bearing which is spaced apart therefrom, which bearings, for example, may be in the form of a rolling ball bearing.

Alternatively, however, it would also be possible to provide a shaft receptacle or shaft bearing, according to which the shaft end WE on the housing presses against the housing portion 4 or a ball which is arranged in the housing portion 4 and in this case forms a hydrodynamic bearing during operation of the distributing device.

In another embodiment, the housing G, 2, 4 itself may form part of a drive unit or an electric motor E. In this case, the distributing disk 6 may be made from a magnetic material. In this case, at least one housing portion which surrounds the distributing disk 6 forms the stator of the electric motor in the form of a, for example, synchronous or reluctance motor.

It would thereby be possible to configure the actuator A with the above-described distributing mechanism in an even more compact manner.

Although, in the preceding description, exemplary embodiments are explained, it may be noted that a large number of modifications are possible. It should be noted, furthermore, that the exemplary embodiments are merely examples which are in no way intended to limit the scope of protection, the applications, and the structure. Instead, the above description gives a person skilled in the art a guideline for the implementation of at least one exemplary embodiment, wherein various changes may be made, especially with regard to the function and arrangement of the component parts described, without departing from the scope of protection as apparent from the combinations of features equivalent thereto.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A distributing device for supplying a pressurized liquid to individual cleaning locations of a vehicle, the distributing device comprising:
a housing, further comprising:
an inlet connection;
a plurality of outlet connections for the individual cleaning locations;
a return connection;
an electromotively drivable, rotatably adjustable distributor which is arranged in the housing and which is in the form of a disk, in which a liquid receiver and a liquid guide are formed, and the distributor is rotatably adjustable relative to the housing in defined positions in order to allow or to prevent the supply of liquid;
wherein the disk controls the liquid to the desired locations of the distributing device via the liquid receiver and the liquid guide at the front side in the form of a radial groove.

2. The distributing device of claim 1, further comprising:
a coherent space fluidically connected to the return connection;
wherein the coherent space is filled by conveyed liquid during operation of the distributing device between the disk and the housing.

3. The distributing device of claim 2, further comprising:
a defined axial gap located between the disk and an associated housing portion of the housing;
wherein, via the defined axial gap, the conveyed liquid propagates in the housing and forms a liquid leakage film on each side of the disk, which spaces the distributor apart from each associated housing portion.

4. The distributing device of claim 1, wherein the disk is formed symmetrically with respect to an axis orthogonal to the longitudinal axis of the disk.

5. The distributing device of claim 1, the disk further comprising a pressure equalizer.

6. The distributing device of claim 5, the pressure equalizer further comprising through-holes.

7. A liquid-distributing actuator comprising:
a distributing device for supplying a pressurized liquid to individual cleaning locations of a vehicle, the distributing device comprising:
a housing, further comprising:
an inlet connection;
a plurality of outlet connections for the individual cleaning locations;
a return connection;
an electromotively drivable, rotatably adjustable distributor which is arranged in the housing and which is in the form of a disk, in which a liquid receiver and a liquid guide are formed, and the distributor is rotatably adjustable relative to the housing in defined positions in order to allow or to prevent the supply of liquid;
wherein the disk controls the liquid to the desired locations of the distributing device via the liquid receiver and the liquid guide at the front side in the form of a radial groove;
an electric motor for driving the rotatably adjustable distributor of the distributing device.

8. A cleaning apparatus for a vehicle for cleaning a large number of cleaning locations on the vehicle, the cleaning apparatus further comprising at least one liquid-distributing actuator of claim 6.

9. A vehicle having a cleaning apparatus of claim 7.
